(19) United States
(12) Patent Application Publication
(10) Pub. No.: US 2003/0116624 A1
(43) Pub. Date: Jun. 26, 2003

(54) Memory card reading device

(75) Inventor: Chie-Yeon Chen, Hsinchu (TW)

Correspondence Address: BACON & THOMAS, PLLC, 625 SLATERS LANE, FOURTH FLOOR, ALEXANDRIA, VA, 22314

(73) Assignee: Winbond Electronics Corp., Hsinchu (TW)

(21) Appl. No.: 10/189,563

(22) Filed: Jul. 8, 2002

(30) Foreign Application Priority Data
Dec. 24, 2001 (TW) 090131962

(51) Int. Cl. G06K 7/06

(52) U.S. Cl. 235/441

(57) ABSTRACT

A memory card reading device comprises a card reader and an adapter. The card reader has a microprocessor, multiple memory card interface circuits, a control circuit, a multiplexer and a connecting port to link with the memory card or the adapter. After the microprocessor and the control circuit detect the specification of the memory card of the adapter, the microprocessor directs the multiplexer to switch to a specific interface circuit corresponding to the detected specification. Therefore the microprocessor can access the data stored on the memory card via the selected specific interface circuit.

### BACKGROUND OF THE INVENTION

1. Field of Invention

The present invention relates to a memory card reading device, and more particularly to a memory card reading device that can access different specifications of memory cards and automatically detect what kind of memory card been inserted into the card reading device.

2. Related Art

Since information appliances, such as a personal digital assistant (PDA), a digital camera, a MP3 player, a notebook computer or things like that, have the advantages of small size and large data storage capacity, those information appliances are widely used. However each of those information appliances has a specific data accessing standard, accordingly the data storage media (memory cards) for those information appliances are developed to many specifications to correspond those different standards.

Currently, memory card specifications include the Compact flash card (CF card), Smart Media card (SM card), Multimedia card (MM card), Security digital card (SD card) and Memory Sticker. The data recorded in those memory cards by the information appliances are often further accessed by a computer. Therefore a computer equipped with a card reader for accessing memory cards is able to indirectly communicate with the information appliances and the data can be shared.

Since memory card specifications have so many varieties, card readers accordingly have been developed to many standards to respectively correspond to the memory cards. For example, when a user wants to obtain the data stored in a CF card, the user needs to purchase a CF card reader and install it in the computer to read/write the CF card. When the user needs to use the information stored in a SM card, another card reader adapted to the SM card needs to be purchased. For a user, such a replacement of the card reader is ineffective use of the computer and causes procurement cost to be high.

To solve the foregoing problems, a conventional universal card reader has been developed. The conventional universal card reader comprises multiple card accessing interfaces to respectively correspond to each type of memory card, wherein each interface is individually connected to a connecting port to receive a corresponding memory card. The conventional universal card reader is an apparatus that integrates different individual memory card readers into a single device. However, the size of the conventional universal card reader is very large, and the manufacturing cost is hard to reduce.

To overcome the shortcomings, the present invention provides a memory card reading device to mitigate and obviate the aforementioned problems.

### SUMMARY OF THE INVENTION

An objective of the invention is to provide a memory card reading device that provides a single connecting port to selectively adopt a card adapter with a specific specification to access a memory card. The card reading device can determine the standard of the memory card based on the specification of the card adapter so as to chose a corresponding interface inside the card reading device for communicating with a computer via the data bus.

To achieve the objective, the memory card reading device in accordance with the present invention comprises a card reader and a card adapter.

The card reader comprises, a microprocessor, multiple memory card interface circuits, a connecting port and a control circuit. The microprocessor is connected to a computer via a data bus. Each of the memory card interface circuits is individually connected to the microprocessor. The connecting port is linked to the memory card interfaces through a multiplexer. The control circuit is connected between the microprocessor and the connecting port.

The card adapter has a connecting interface to link to the connecting port of the card reader.

When the card adapter for a memory card is linked to the card reader, the control circuit of the card reader can determine the specification of the adapter. When the specification of the adapter is determined, the microprocessor selects an interface circuit through the multiplexer, which corresponds to the memory card inside the adapter so the microprocessor can access the memory card through the selected interface circuit. Therefore, the computer can access the data in the memory card through the data bus, the microprocessor and the selected card interface circuit.

The connecting port of the card reader is designed to match a CF memory card, so the card reader can directly receive the CF memory card without any card adapters, wherein the control circuit inside the card reader utilizes the particular data I/O pins of a CF memory card to recognize that the card been inserted in the card reader is a CF card. Other memory cards need to be inserted into a corresponding adapter to communicate with the card reader. When a card adapter that receives a memory card is inserted into the card reader, the control circuit inside the card reader can recognize the specification of the memory card by detecting some specific pins of the card adapter.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a memory card reading device in accordance with the present invention;

FIG. 2 is a block diagram of the memory card reading device in FIG. 1;

FIG. 3 is a block diagram of the memory card reading device in FIG. 1, wherein the card reader receives a CF memory card;

FIG. 4 is a partial circuit diagram of a control circuit used to detect a CF memory card in accordance with the present invention;

FIG. 5 is a block diagram of the memory card reading device in FIG. 1, wherein the card reader is linked with a SM card adapter that receives a SM card; and

FIG. 6 is a schematic view of an MMC card adapter with an MMC card.

### DETAILED DESCRIPTION OF THE INVENTION

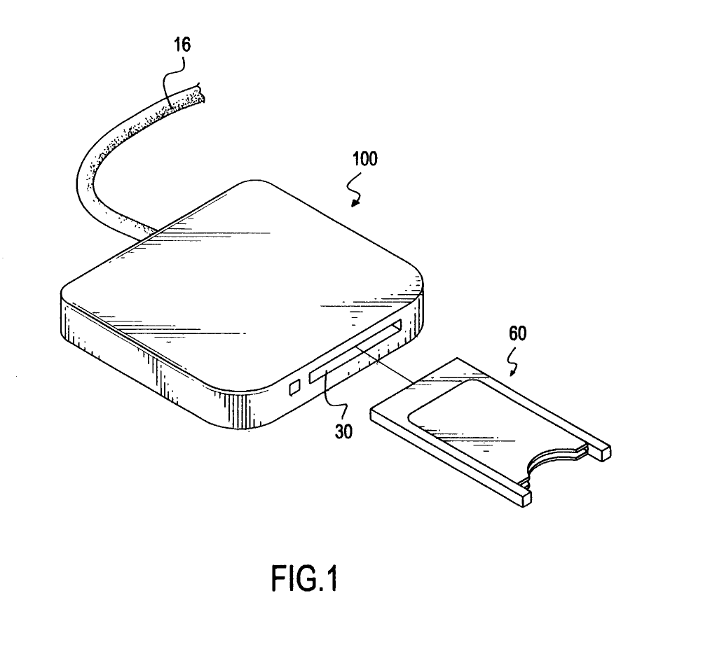

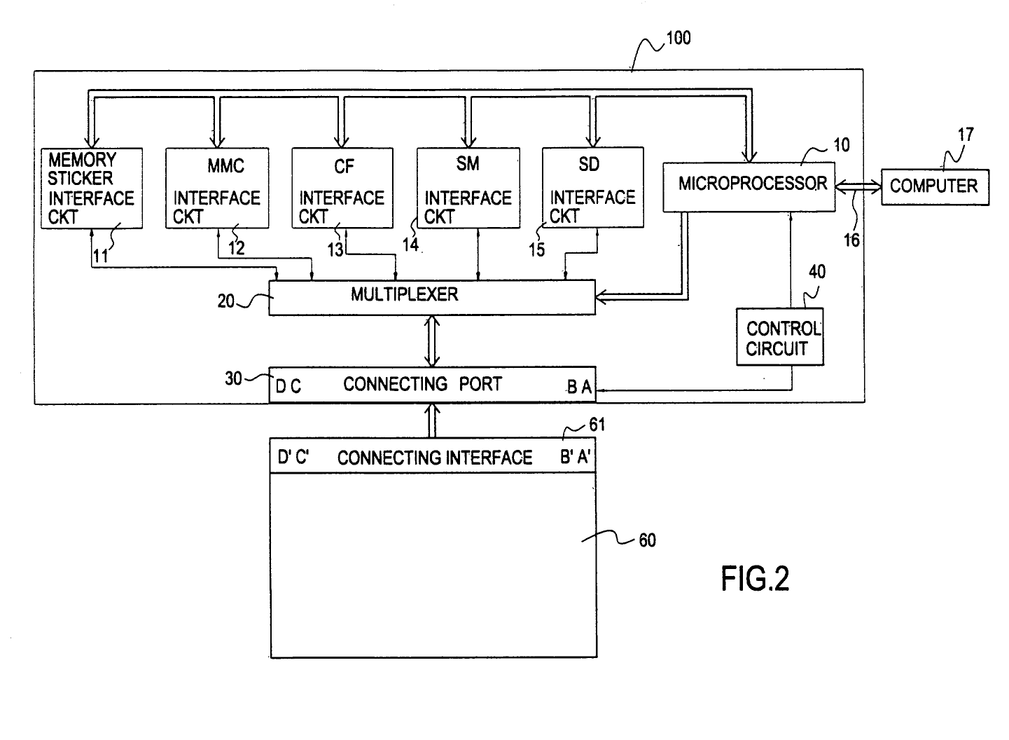

With reference to FIGS. 1 and 2, a memory card reading device in accordance with the present invention comprises a card reader (100) and a card adapter (60).

The card reader (100) includes a microprocessor (10), multiple memory card interface circuits (11-15), a multiplexer (20), a connecting port (30) and a control circuit (40). The microprocessor (10) connects to a computer (17) via a data bus (16). The memory card interface circuits (11-15) comprise a Memory Sticker interface circuit (11), a Multimedia card (MMC) interface circuit (12), a Compact flash card (CF) interface circuit (13), a Smart Media card (SM card) interface circuit (14) and a Security digital card (SD card) interface circuit (15).

The multiplexer (20) couples to each memory interface circuit (11-15) and the microprocessor (10). The control circuit (40) is provided between the microprocessor (10) and the connecting port (30) to detect the specification of a card adapter (60) inserted into the connecting port (30).

Since the CF card has the biggest size and the most contact pins among the different memory cards nowadays, the contact pins inside the connecting port (30) are designed to accommodate the CF card.

The card adapter (60) for receiving a memory card (not shown) has a connecting interface (61) to link with the connecting port (30) of the card reader (100). The circuit layout of the contact pins in the connecting interface (61) varies based oil the specifications of the different memory cards.

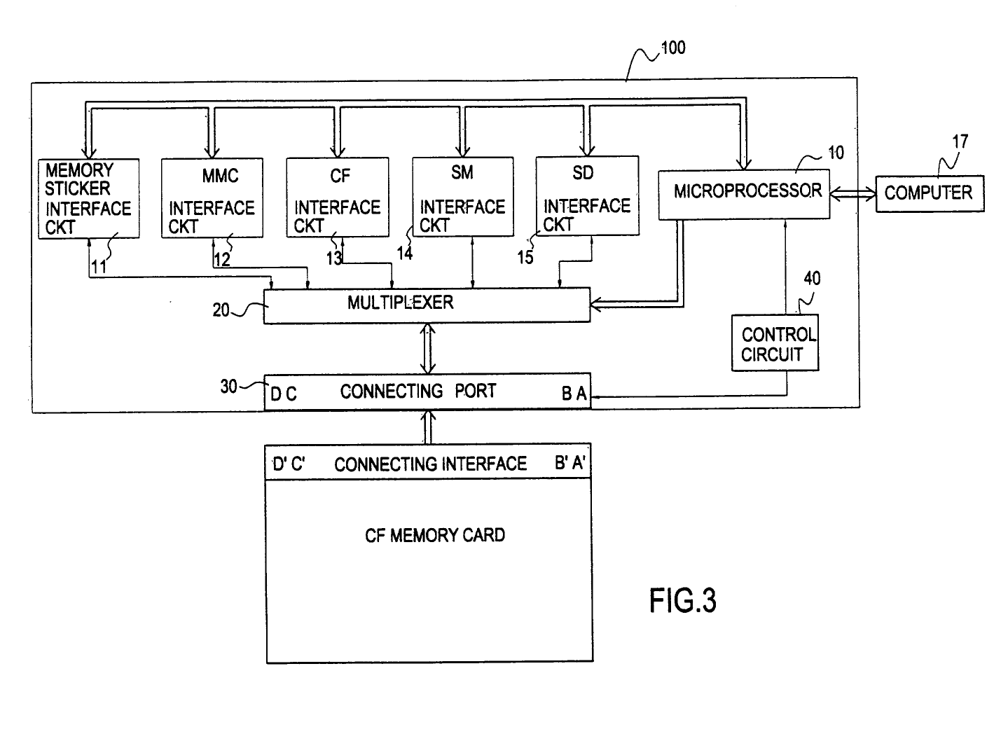

With reference to FIG. 3, since the contact pins of the connecting port (30) are designed to correspond to a CF memory card, the CF memory card can be inserted directly into the connecting port (30) without any card adapter (60). When the CF memory card is linked to the connecting port (30), the control circuit (40) first outputs control signals to disable some contact pins (A′, B′, C′ and D′) of the CF memory card through the pins (A, B, C and D) of the connecting port (30). Then the control circuit (40) detects the voltage level of each contact pins.

For a CF memory card, some specific I/O pins (as labeled with A′, B′, C′ and D′ in FIG. 2), such as the IOR, IOW and REG pins, normally keep a high voltage level. Those I/O pins only change to a low voltage level when the CF memory card is transferring or reading data. Even though the control signals were sent to disable those specific pins, those specific I/O pins still remain at a high voltage level. When the control circuit (40) obtains the voltage level of each pin, the control circuit (40) determines the specification of the CF memory card based on the presented voltage level of each I/O pin. Therefore, the CF card interface circuit (13) is selected, and the computer can access the CF card through the data bus (16) and the selected CF interface circuit (13).

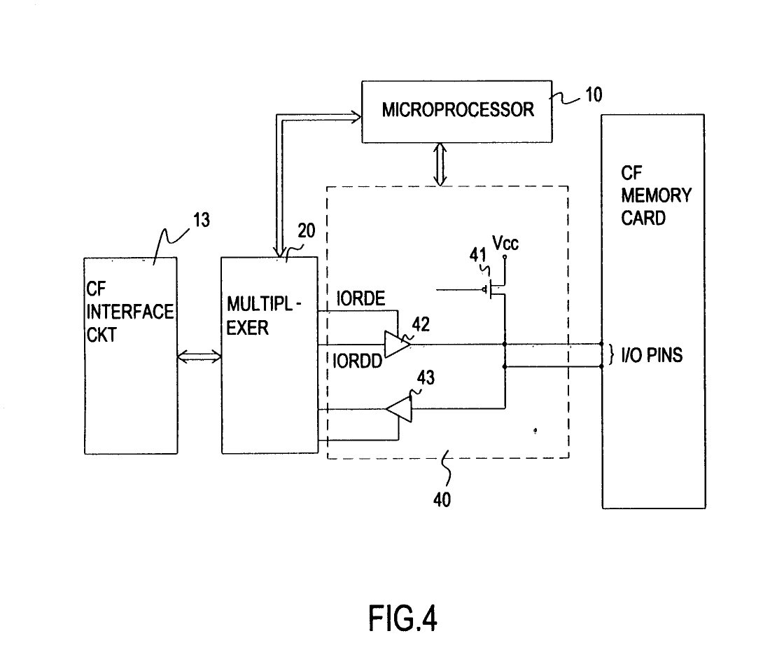

With reference to FIG. 4, the previously described determination of whether the memory card is a CF memory card is based on the specific state of some I/O pins of the CF memory card. However, the voltage level of the specific I/O pins will vary when the data on the card is accessed. Thus, determination that the card in the card reader (100) is a CF memory card must be finished before the computer (17) (not shown in FIG. 4) begins using data on the card. When the computer (17) is activated, a first tri-state switching element (43) and a transistor (41) connected between the power (VCC) and the I/O pins in the control circuit (40) are turned on. Thus the specific I/O pins can be kept at the high voltage level. After the microprocessor (10) obtains the voltage level information and determines that the memory card is a CF memory card, the microprocessor (10) causes the multiplexer (20) to select the CF interface circuit (13).

Once the determination processing of the CF memory card is completed, the transistor (41) and the first tri-state switching element (43) are turned off. So the voltage level of the specific I/O pins of the CF card keep at a low voltage level. When the CF memory card is read/wrote by the microprocessor (10), a second tri-state switching element (42) in the control circuit (40) is turned on. Otherwise the second tri-state switching element (42) is off. Thus the microprocessor (10) can access the data on the CF memory card via the selected CF interface circuit (13).

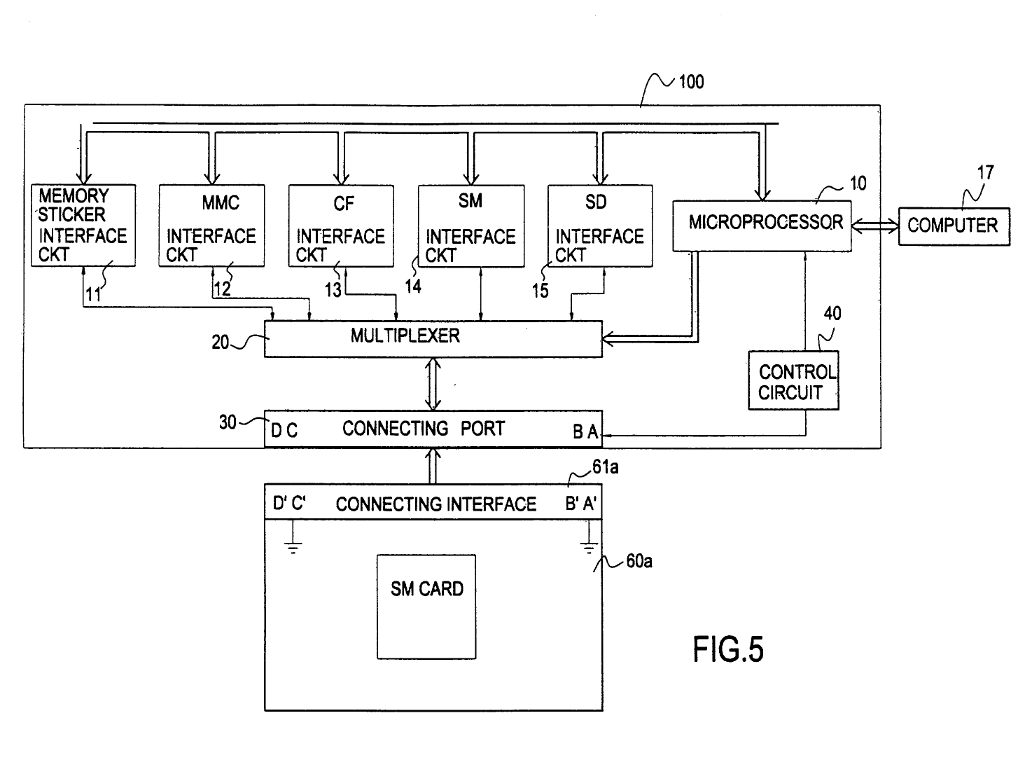

With reference to FIG. 5, when the card reader (100) accesses other memory cards, such as a SM card, the SM card must be inserted into a SM card adapter (60a) first. The SM card adapter (60) with the SM card is connected to the connecting port (30). Several specific I/O pins (A′, B′, C′ and D′) of the connecting interface (61a) of the SM card adapter (60a) respectively contact the corresponding pins (A, B, C and D) of the card reader (100). In this embodiment, the I/O pins A′ and C′ of the SM card adapter (60a) are designed to connect to ground. When the adapter (60a) connects to the card reader (100), the microprocessor (10) and the control circuit (40) detects that pins A and C are both in the low voltage level. Therefore, the microprocessor (10) can recognize that the card inserted is a SM memory card.

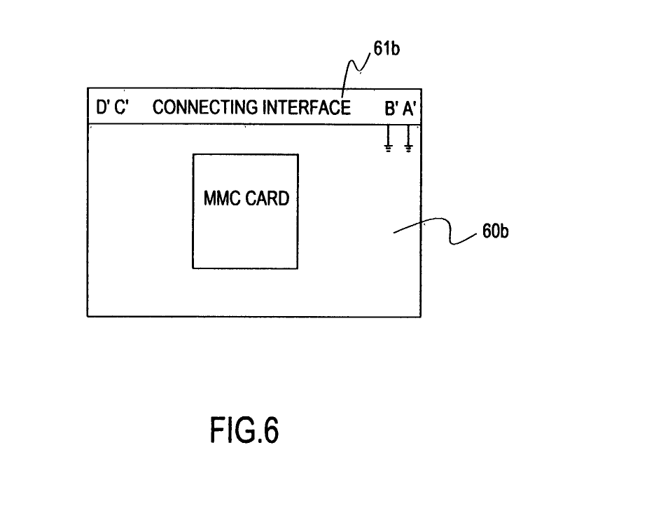

With reference to FIG. 6, if the card reader (100) is used to access a MMC card, the I/O pins A′ and B′ of the MMC card adapter (60b) are designed to connect to ground. When the adapter (60b) is connected to the card reader (100), the microprocessor (10) and the control circuit (40) detect a low voltage level on pins A and B. Thus the card reader (100) easily determines that the memory card inserted is an MMC card based on the voltage levels.

With reference to FIGS. 5 and 6, the card reader (100) can access different memory cards by using the corresponding adapters (60). Only the circuit layout of the I/O pins in the connecting interface (61a, 61b) of each adapter (60a, 60b) need to be changed. Therefore, depending on different voltage levels on specific I/O pins, the microprocessor (10) and the control circuit (40) of the card reader (100) can determine the specification of the specific memory card installed in the card reader (100).

The card adapter (60) previously mentioned also can be fabricated as an adapting circuit to receive a memory card, and all the determination of memory cards are the same as the card adapter (60).

The invention may be varied in many ways by a skilled person in the art. Such variations are not to be regarded as a departure from the spirit and scope of the invention, and all such modifications are intended to be included within the scope of the following

What is claimed is:

1. A memory card reading device comprising:
a card reader, wherein said card reader comprises:
a microprocessor coupled to a data bus;
a plurality of memory card interface circuits coupled to said microprocessor;
a connecting port coupled to said plurality of memory card interface circuits through a multiplexer, wherein said multiplexer is controlled by said microprocessor; and
a control circuit coupled to said microprocessor and said connecting port; and
an adapter to receive a memory card, wherein said adapter coupled to said connecting port of said card reader through a connecting interface;
wherein said card reader can detect the specification of said memory card by said control circuit and said microprocessor, and select a corresponding memory card interface circuit from said plurality of memory card interface circuits, whereby said microprocessor can access data stored in said memory card inside said adapter via said selected memory card interface circuit.

2. The memory card reading device as claimed in claim 1, wherein said connecting port has a plurality of pins corresponding to a plurality of contact pins of said adapter, wherein a circuit layout of said plurality of contact pins is varied based on said specification of said memory card, so that said card reader can detect the specification of said adapter.

3. The memory card reading device as claimed in claim 2, wherein said connecting port is able to directly access a CF memory card.

4. The memory card reading device as claimed in claim 2, wherein said plurality of contact pins comprise an IOR and an IOW pin.

5. The memory card reading device as claimed in claim 2, wherein said plurality of contact pins is normally kept at a high voltage level.

6. The memory card reading device as claimed in claim 1, wherein said control circuit comprises at least one tri-state switching element.

7. The memory card reading device as claimed in claim 1, wherein said control circuit comprises a transistor connected between a power source and said plurality of pins.

8. A memory card reading device comprising:
a card reader, wherein said card reader comprises:
a microprocessor coupled to a data bus;
a plurality of memory card interface circuits connected to said microprocessor;
a connecting port connected to said plurality of memory card interface circuits through a multiplexer, wherein said multiplexer is controlled by said microprocessor; and
a control circuit coupled to said microprocessor and said connecting port; and
an adapting circuit to receive a memory card, wherein said adapting circuit coupled to said connecting port of said card reader through a connecting interface;
wherein said card reader can detect the specification of said memory card by said control circuit and said microprocessor, and select a memory card interface circuit from said plurality of memory card interface circuits, whereby said microprocessor can access data stored in said memory card inside said adapting circuit via said selected memory card interface circuit.

9. The memory card reading device as claimed in claim 8, wherein said connecting port has a plurality of pins corresponding to a plurality of contact pins of said adapting circuit, wherein a circuit layout of said plurality of contact pins is varied based on said specification of said memory card, so that said card reader can detect the specification of said adapting circuit.

10. The memory card reading device as claimed in claim 9, wherein said connecting port is able to directly access a CF memory card.

11. The memory card reading device as claimed in claim 9, wherein said plurality of contact pins comprise an IOR and an IOW pin.

12. The memory card reading device as claimed in claim 9, wherein said plurality of contact pins is normally kept at a high voltage level.

13. The memory card reading device as claimed in claim 8, wherein said control circuit comprises at least one tri-state switching element.

14. The memory card reading device as claimed in claim 8, wherein said control circuit comprises a transistor connected between a power source and said plurality of pins.
